(19) United States
(12) Patent Application Publication
(10) Pub. No.: US 2003/0056998 A1
(43) Pub. Date: Mar. 27, 2003

(54) E-mail informable handwriting-input device

(76) Inventor: Ming-Hsiang Liu, Yi-Lan City (TW)

Correspondence Address: SUPREME PATENT SERVICES, POST OFFICE BOX 2339, SARATOGA, CA, 95070, US

(21) Appl. No.: 09/965,420

(22) Filed: Sep. 27, 2001

(51) Int. Cl. G06K 11/06

(52) U.S. Cl. 178/18.01

(57) ABSTRACT

An e-mail informable handwriting-input device is connected with an electronic machine capable of transmitting and receiving e-mails so that the electronic machine can forward a signal to the handwriting-input device upon receipt of an e-mail, and in turn, the handwriting-input device will relay the same to a user. The handwriting-input device comprises: an e-mail reception-signal input unit for receiving an e-mail arrival signal come from the electronic machine; an e-mail reception-signal output unit for output of a signal to remind a user of the arrival of e-mail; and an e-mail reception-signal processing unit for treating the signal received and instructing the e-mail reception-signal output unit to effect an output signal.

### FIELD OF THE INVENTION

This invention relates generally to handwriting-input devices, particularly to a handwriting-input device capable of keeping a user informed of any new e-mail upon receipt when the user is operating an electronic machine having an e-mail transceiver software.

### BACKGROUND OF THE INVENTION

The recent e-mail transceiver software is programmed to transmit a notice signal of e-mail reception to a user, however, the user may not be perceptive of the signal when he is engaged in operating a digitizer tablet for graphing in full-screen mode for example.

In view of said defect, this invention is to propose a handwriting-input device that can offer a signal in real time to the user upon receipt of an e-mail in order not to miss any.

### SUMMARY OF THE INVENTION

The primary object of this invention is to provide an e-mail informable handwriting-input device capable of notifying a user upon receipt of a new e-mail.

In order to realize abovesaid object, the handwriting-input device of this invention is connected with an electronic machine capable of transmitting and receiving e-mails so that the electronic machine can forward a signal to the handwriting-input device upon receipt of an e-mail, and in turn, the handwriting-input device will relay the same to a user. The handwriting-input device comprises: an e-mail reception-signal input unit for receiving an e-mail arrival signal come from the electronic machine; an e-mail reception-signal output unit for output of a signal to remind a user of the arrival of an e-mail; and an e-mail reception-signal processing unit for treating the signal received and instructing the e-mail reception-signal output unit to effect an output signal.

For more detailed information regarding advantages or features of this invention, at least an example of preferred embodiment will be elucidated below with reference to the annexed drawings.

### BRIEF DESCRIPTION OF THE DRAWINGS

The related drawings in connection with the detailed description of this invention to be made later are described briefly as follows, in which:

FIG. 1 is a block diagram showing the hardware architecture of an e-mail informable handwriting-input device of this invention; and

FIG. 2 is a working flowchart of the e-mail informable handwriting-input device of this invention.

### DETAILED DESCRIPTION OF THE INVENTION

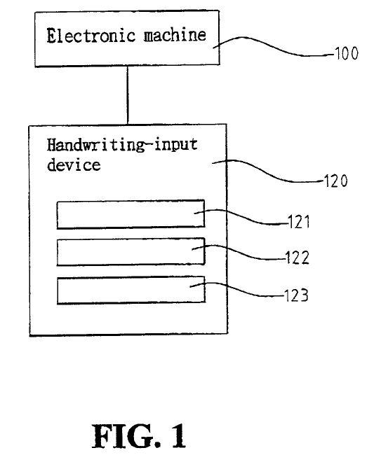

As indicated in FIG. 1-a block diagram showing the hardware architecture of an e-mail informable handwriting-input device of this invention-an electronic machine 100 capable of transmitting and receiving e-mails is connected with a handwriting-input device 120 so that an arrival signal of e-mail is sent from the electronic machine 100 upon receipt of an e-mail to the handwriting-input device 120, which then relays the same to remind a user of the arrival of e-mail.

The handwriting-input device 120 comprises: an e-mail reception-signal input unit 121 for receiving an e-mail arrival signal come from the electronic machine 100; an e-mail reception-signal output unit 122 for output of a signal to remind a user of the arrival of e-mail; and an e-mail reception-signal processing unit 123 for treating the signal received and instructing the e-mail reception-signal output unit 122 to effect an output signal to remind the user of the arrival of e-mail.

The e-mail reception-signal input unit 121 shown in FIG. 1 is substantially a communication-connecting port of RS232 (Recommended Standard), Universal Serial Bus (USB), or Infrared Ray (IR) communication and transmission, etc. The e-mail reception-signal processing unit 123 is a microprocessor. The e-mail reception-signal output unit 122 may be a lighting device to emit flash or color-changing light, or may be a buzzer for reminding a user of the arrival of e-mail.

The electronic machine 100 shown in FIG. 1 may be a personal computer (PC) or an information appliance (IA), while the handwriting-input device of this invention may be a digitizer tablet, a tact control tablet, etc.

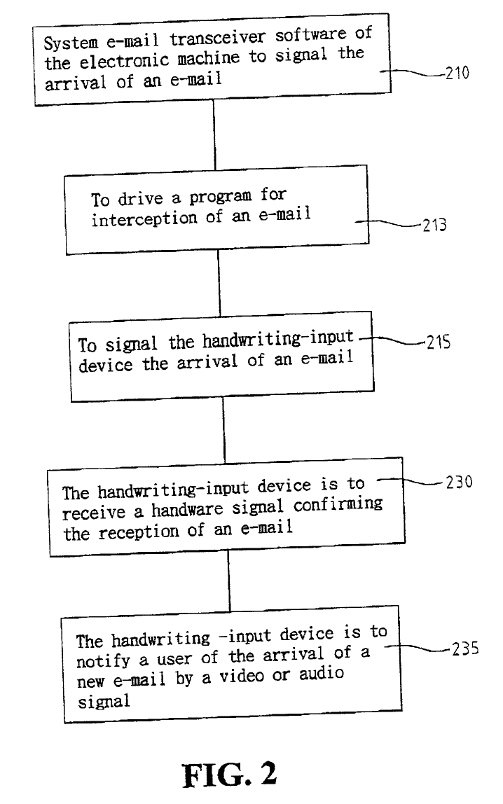

A working flowchart of the e-mail informable handwriting-input device of this invention is shown in FIG. 2, wherein a step 210 is the step for a system e-mail transceiver software of the electronic machine 100 to signal the arrival of an e-mail; a step 213 is the step for the electronic machine 100 to drive a program for interception of the e-mail; a step 215 is the step for the electronic machine 100 to signal the handwriting-input device 120 the arrival of an e-mail; a step 230 is the step for the handwriting-input device 120 to receive a hardware signal confirming the reception of the e-mail; and a step 235 is the step for the handwriting-input device 120 to notify a user of the arrival of a new e-mail by a video signal, such as flash light or color-changing light, or by an audio signal such as buzz of a buzzer.

As described above, the steps 210 through 215 are performed by the electronic machine 100 while the steps 230 and 235 by the handwriting-input device 120, wherein the steps 230 and 235 may be programmed in instruction codes to be executed by the e-mail reception-signal processing unit 123 so that the e-mail reception-signal input unit 121 will receive a hardware signal expressing the reception of a new e-mail and the e-mail reception-signal output unit 122 will notify a user of the arrival of the new e-mail by variation of sound or light.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. An e-mail informable handwriting-input device, which is connected with an electronic machine capable of transmitting or receiving e-mails, which will forward an arrival signal of e-mail to the handwriting-input device upon receipt of an e-mail for the latter to relay the same to a user, the handwriting-input device comprising:
an e-mail reception-signal input unit for receiving an e-mail arrival signal come from the electronic machine;
an e-mail reception-signal output unit for output of a signal to remind a user of the arrival of e-mail; and
an e-mail reception-signal processing unit for treating the signal received and instructing the e-mail reception-signal output unit to effect an output signal to remind the user of the arrival of e-mail.

2. The e-mail informable handwriting-input device according to claim 1, wherein the e-mail reception-signal in put unit is a communication connecting port.

3. The e-mail informable handwriting-input device according to claim 1, wherein the e-mail reception-signal processing unit is a microprocessor.

4. The e-mail informable handwriting-input device according to claim 1, the e-mail reception-signal output unit is a lighting device for emanating flash or color-changing light to remind a user of the arrival of an e-mail.

5. The e-mail informable handwriting-input device according to claim 1, wherein the e-mail reception-signal output unit is a buzzer for buzzing to remind a user of the arrival of an e-mail.

6. The e-mail informable handwriting-input device according to claim 1, which is a digitizer tablet.

7. The e-mail informable handwriting-input device according to claim 1, which is a tact control tablet.
